(19) United States
(12) Patent Application Publication
(10) Pub. No.: US 2025/0032214 A1
(43) Pub. Date: Jan. 30, 2025

(54) METHOD FOR WARNING OF AN INSTRUMENT BREAK RISK

(71) Applicants: Walid NEHME, BEIRUT (LB); MICRO-MEGA INTERNATIONAL, BESANCON (FR)

(72) Inventors: Walid NEHME, BEIRUT (LB); Stéphane CLAUDE, LA ROCHE (CH)

(73) Assignees: Walid NEHME, BEIRUT (LB); MICRO-MEGA INTERNATIONAL, BESANCON (FR)

(21) Appl. No.: 18/715,346

(22) PCT Filed: Sep. 27, 2022
(86) PCT No.: PCT/FR2022/051826

§ 371 Date: May 31, 2024

(30) Foreign Application Priority Data
Dec. 9, 2021 (FR) FR2113220

(51) Int. Cl. A61C 5/48; A61C 1/00; A61C 1/08; A61C 1/12; A61C 19/04

(52) U.S. Cl. CPC A61C 5/48; A61C 1/0015; A61C 1/082; A61C 1/12; A61C 19/041

(57) ABSTRACT

A method for warning of an instrument break risk during an endodontic treatment. The method includes the following steps: acquiring the shape of a root canal to be treated; identifying a risk zone, on the basis of complexities in the shape of the canal, such as bends or bifurcations in the canal; in real-time, acquiring a working depth of the instrument; determining the position of the instrument within the canal, and issuing a warning when the instrument reaches the risk zone.

### TECHNICAL FIELD

The invention relates to the technical field of endodontics.

### PRIOR ART

The endodontic treatment of a root canal consists in evacuating the tissues of this canal. To perform this operation, the practitioner uses canal instruments, such as exploration files, in order to locate the trajectory of the canal, accurately determine the length of the canal, then evacuate the tissues by means of another file before shaping the canal for sealing thereof.

During an endodontic treatment, instrumental breakage is one of the most frequent complications. The direct complications of this instrumental break are of clinical order:
if it is possible to recover the instrument fragments, the consequences are an increase in the duration of the treatment and a potential weakening of the tooth by a reduction in the residual wall thickness necessary for the removal of the fragments;
if it is not possible to recover the instrument fragments, the consequences could (i) be related to an insufficient disinfection of the canal network resulting in post-operative pain, non-healing and therefore a failure of the endodontic treatment or (ii) be related to the apparition of an infectious process that did not exist at the time of treatment and resulting in pains and failures of the treatment in the short to medium term.

The occurrences of instrumental breaks are generally reduced by the design of the canal instruments, in order to make them more resistant to the stresses exerted during the endodontic treatment.

Nonetheless, an instrumental strand is a rapid event, which might occur in less than a few seconds, and it is difficult to know the conditions in which the break has occurred.

Several parameters could influence the occurrence of a break, such as:
the geometry of the treated canal, in particular if it has a complex geometry, with a sudden change in direction forming a bend;
the irrigation of the canal, implemented, or not, by the practitioner during some phases of the treatment;
the force that the practitioner exerts on the instrument.

Hence, the possibilities for improving the design of the instruments are limited by the lack of knowledge of these multiple parameters.

It is also difficult, even for an experienced practitioner, to accurately know how an instrument is moving within the canal being treated. Even though the practitioner knows that the canal that he/she will treat is complex, and he/she estimates the necessary precautions, he/she can make a mistake and not correctly adapt his/her gesture or the drive dynamics of the instrument to the complexity of the canal, which might lead to an instrumental break.

### DISCLOSURE OF THE INVENTION

The invention aims to overcome the drawbacks of the prior art, by proposing a method for assisting a practitioner during the treatment of root canals.

To this end, a method for warning of an instrument break risk has been developed.

According to the invention, the method comprises the following steps:
acquiring data of a geometry of a root canal to be treated;
identifying a risk zone, based on complexities of the geometry of the canal such as bends or bifurcations of the canal;
acquiring in real-time a working depth of the instrument;
determining a position of the instrument within the canal, and issuing a warning when the instrument reaches the risk zone.

In this manner, it is possible to know in real-time where the instrument is located within the canal during the treatment, and consequently determine whether the instrument will approach a predetermined risk zone of the canal before carrying out the treatment, for example by the practitioner, according to the geometry of the canal.

For the practitioner to be warned when the instrument will approach a zone at risk of the canal, the method comprises a step of informing the practitioner on the position.

For simplicity of information diffusion to the practitioner, the warning is visual, haptic or audible.

Advantageously, the method comprises a step of comparing the geometry of the root canal to be treated with a database comprising records of prior root canal treatments, the records comprising:
geometries of the treated canals;
local stresses within a material making up instruments used, obtained by finite-element calculation based on the geometry of the canal, a geometry of the instrument, a working depth of the instrument at a given interval and a stress experienced by the instrument at that same given interval;
the step of comparing with the records of the prior treatments allowing identifying risk zones of the canal to be treated, where local stresses will be high within the instrument.

Such a method allows further assisting the practitioner, by automatically identifying the risk zones based on prior treatments already completed, which guarantees the relevance of the identification of said zones, and simplifies the use of the method.

Since the database is evolutive, the method can also adapt its criteria for determining the risk zones for the evolutions of the database or to the evolutions of the design of the instruments and/or of the intended conditions of use.

Advantageously, the method comprises a step of adapting instrumental dynamics when the instrument reaches the risk zone. In this manner, the assistance of the practitioner is complete, and the method plays an active role in the prevention of instrumental breakage.

The invention also relates to a handpiece for endodontic practice, comprising a control unit executing a computer program, and designed to drive a canal instrument.

According to the invention, the handpiece comprises means for detecting a distance between a reference point and a portion of a tooth, as well as means for measuring mechanical stresses experienced by the instrument, connected to the control unit. The computer program is programmed to determine a depth at which the instrument at work is located according to a known length of the instrument, and the computer program is configured to detect risk zones of the canal to be treated by comparing its geometry with records of prior treatments, the records comprising:
geometries of treated canals;
local stresses within a material making up instruments used, obtained by finite-element calculation based on the geometry of the canal, a geometry of the instrument, a working depth of the instrument at a given time point, or given interval, and a stress experienced by the instrument at that same given time point, or given interval.

The computer program is configured to warn the practitioner when the instrument is in a risk zone.

The handpiece thus designed comprises all the structural elements necessary to implement the method according to the aforementioned features, with the advantages resulting therefrom.

### BRIEF DESCRIPTION OF THE DRAWINGS

FIG. 1 is a diagram of a tooth, illustrating the geometry of a canal to be treated.

FIG. 2 is a diagram of a canal instrument.

FIG. 3 is an illustration of a handpiece according to the invention.

FIG. 4 is a diagram illustrating such a handpiece during use.

FIG. 5 is a diagram of a treatment in a first configuration.

FIG. 6 is a diagram of a finite-element calculation in this first configuration.

FIG. 7 is a diagram of the treatment in a second configuration.

FIG. 8 is a diagram of a finite-element calculation in this second configuration.

FIG. 9 is a diagram illustrating a database categorising different geometries of root canals.

### DETAILED DESCRIPTION OF THE INVENTION

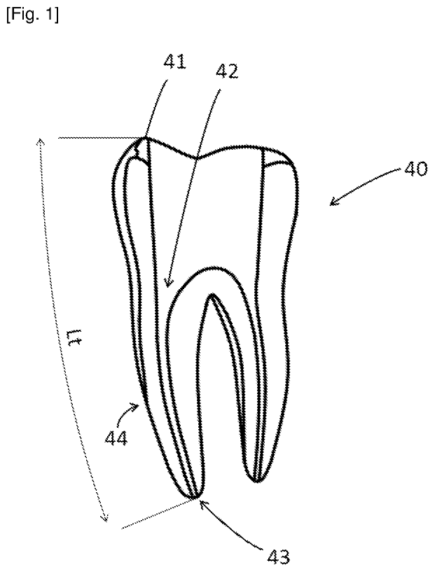

Referring to FIG. 1, an endodontic treatment consists in removing the tissues from a root canal (42) of a tooth (40). During this treatment, it is recommended to use an instrument (20), such as a file, up to the apex (43) of the canal (42). The length between a portion (41) of the tooth (40), generally a cusp, and the apex (43) is the working length (Lt).

The canal (42) being approximately filiform, the lengths are measured according to the developed flat of the canal (42). Nonetheless, the canal (42) may have different types of geometries, which has an influence on the complexity of the treatment to be performed.

A canal (42) may be rectilinear, in which case the treatment will be simple. Conversely, a canal (42) having a curvature (44) will impart a stress on the instrument (20). In the extreme case where this curvature (44) is in the form of a bend, the stress level is such that it could lead to breakage of the instrument (20).

Hence, it is common to obtain an acquisition of the geometry of the canal (42) to be treated, for example by radiography, so that the practitioner could better anticipate his/her gesture, and could predict which are the risk zones where the instrument (20) is at risk of breaking.

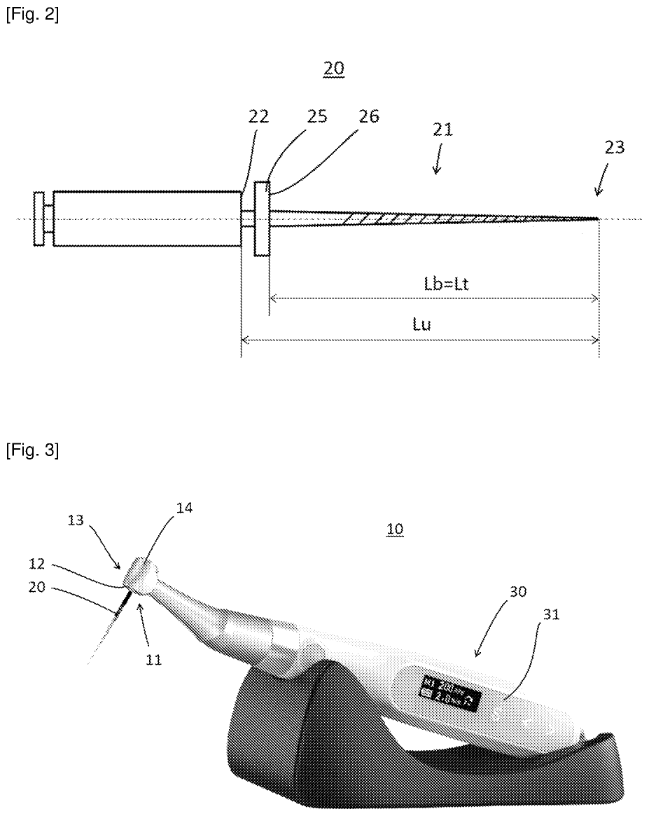

Referring to FIG. 2, an instrument (20) is generally provided with a stop (25) made of an elastomeric material. The position of this stop is adjusted by the practitioner so that the stop length (Lb), defined by the distance between the tip (23) of the instrument (20) and an underside (26) of the stop (25), is equal to the working length (Lt). Hence, the stop length (Lb) is shorter than or equal to a useful length (Lu) of the instrument (20).

In this manner, when the practitioner carries out his/her treatment and digs the canal (42) with the instrument (20), he/she knows that when the underside (26) comes into contact with the portion (41), then the tip (23) is at the apex (43). However, as long as the underside (26) is not in contact with the portion (41), the practitioner has no precise information on the position of the instrument (20) within the canal (42) so that the instrument (20) might approach a curvature (44), or a risk zone, while the practitioner is not prepared to that.

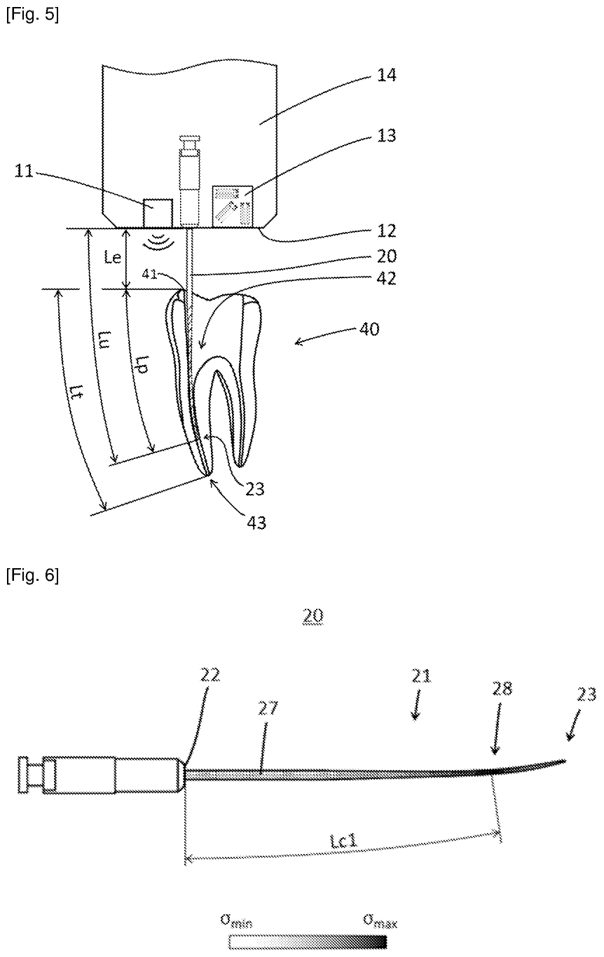

Referring to FIGS. 3 to 5, the handpiece (10) according to the invention comprises a control unit (30) controlling a motor intended to drive an instrument (20) according to suitable dynamics, via a contra-angle (14).

The handpiece (10) comprises a depth meter (11) allowing knowing in real-time at which working depth (Lp) the instrument is located within the canal (42). The depth meter (11) comprises detection means which measure a distance (Le) between the portion (41) of the tooth (40) and the reference point (12) which is preferably on the handpiece (10).

Subtracting the distance (Le) from the useful length (Li) gives the working depth (Lp) at which the instrument (20) is located at a given time point.

Using the acquisition of the geometry of the canal (42) and the working depth (Lp) at a given time point, it is possible to know whether the tip (23) is about to approach a risk zone (44). More generally, it is also possible to reconstruct the geometry that the instrument (20) has at this given time point, since it is conformed by the trajectory of the canal (42).

The handpiece (10) also comprises means (13) for measuring the mechanical stresses experienced by the instrument (20). The measurement means (13) are of any suitable type, and may consist of dynamometers or strain gauges. Preferably, these consist of strain gauges, for example axial strain gauges or in the form of rosettes. Indeed, these strain gauges are barely bulky, durable, and their output signal is easy to interpret.

For the measurements to be the least erroneous possible, the depth meter (11) and the measurement means (13) are preferably arranged on the contra-angle (14).

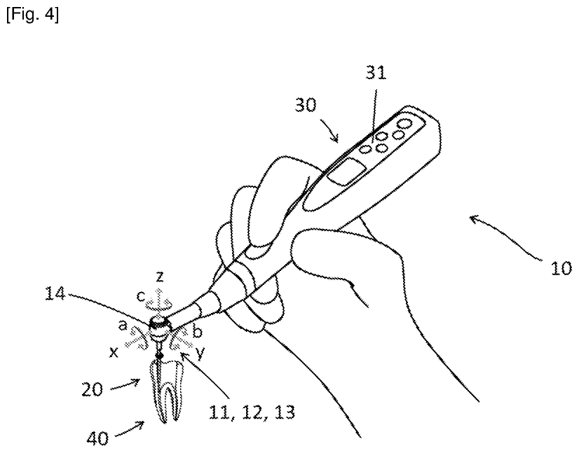

In order to have as much information as possible about the conditions of use of the instrument (20), the measurement means (13) are preferably configured to measure the stresses experienced by the instrument (20) according to three axes of an orthonormal reference frame. Referring to FIG. 4, this consists in collecting the forces (x, y, z) as well as the torques (a, b, c). Thus, it is possible to completely obtain the screw of the forces experienced by the instrument (20).

Referring to FIG. 6, the knowledge of the configuration in which the instrument (20) is conformed by the canal (42) at each time point, as well as the mechanical stresses it experiences, allows carrying out a posteriori analysis by a finite-element method of the effective distribution of the mechanical stresses within the instrument (20).

This analysis takes account of the design of the instrument (20), i.e. the material in which it is made, its nominal geometry such as its dimensions and its cutting lips, as well as any treatments that the instrument (20) has undergone during manufacture thereof, for example a heat treatment.

The subdivision of the instrument (20) into a mesh (27), the knowledge of the stress screw to which the instrument (20) is subjected, and the choice of conditions at the limits based on the acquisition of the geometry of the canal (42) allow calculating how the stresses within the instrument (20) are distributed, and in particular knowing the maximum stress zone(s) (28) at the chosen given time point. In FIG. 6, the maximum stress zone (28) is located at a first length (Lc1).

The working depth (Lp) as well as the stresses evolve during the treatment.

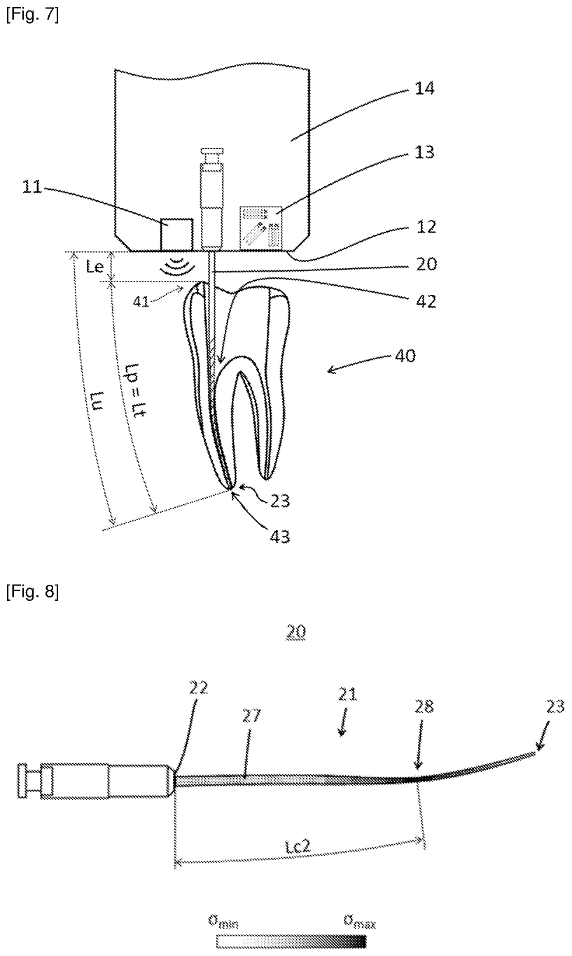

In FIG. 7, the tip (23) of the instrument (20) reaches the apex (43). The canal (42) conforms the instrument (20) according to a determined configuration, and one could see in FIG. 8 that the maximum stress zone (28) has shifted to a second length (Lc2), shorter than the first length (Lc1).

The real-time recording of the working depth (Lp) of the instrument (20) as well as of the stresses experienced thereby allows carrying out a posteriori a multitude of finite-element analyses, enabling the designers of endodontic materials to best design the equipment as well as the conditions of use thereof.

Based on the performed calculations:
the manufacturer of the instrument (20) can modify the geometry, the material or the treatments of the instrument (20);
the manufacturer of the instrument (20) can modify the intended conditions of use, such as the rotational speed of the instrumental dynamics;
the manufacturer of the handpiece (10) can integrate additional safety functions in the computer program executed by the control unit (30).

In order to make available a database that is sufficient for equipment manufacturers, the program of the control unit (30) is programmed to record at regular intervals, for each treatment:
the working depth (Lp) of the instrument (20);
the mechanical stresses experienced by the instrument (20).

The intervals may be a distance, for example a 0.5 mm step. Hence, the database contains a record of the conditions of use of the instrument (20) in each configuration imposed by the geometry of the canal. The size of the database is limited.

The intervals may be a duration, for example a 0.5 s step. The database is larger because the practitioner performs back-and-forth movements during the treatment: there are therefore several records for a given working depth (Lp), but the records are much more complete and allow better monitoring the evolution, at all times, of the conditions of use of the instrument (20).

The records also comprise:
the reference of the used instrument (20), which allows obtaining the characteristics necessary for the finite-element analysis, by consulting an additional database comprising the mechanical characteristics of the instruments (20) intended to be used in cooperation with the handpiece (10);
the acquisition of the geometry of the canal (42), which is preferably a three-dimensional acquisition so that the analysis by the finite-element method is as relevant as possible.

The records may be accompanied by additional data acquired by the control unit (30), for example the time points when the irrigation of the canal (42) was activated or not, the irrigation allowing evacuating the debris and lubricating the cut of the instrument (20). These may also consist of the parameters of the instrumental dynamics, such as the rotational speed, the reciprocity angles, or the torque exerted by the motor.

These records may also be accompanied by data entered by the practitioner, preferably by means of the control unit (30) or by means of a computer connected to the record database. For example, the practitioner could declare whether an instrumental break has occurred, so that the a posteriori analysis is targeted on the treatments that have led to breakage.

For the purpose of automation of the process, breakage of the instrument (20) is automatically detected by the computer program, for example by identifying a discontinuity in the measurement of the stresses: a sudden relaxation of the stress means that the instrument (20) has broken.

The analysis of several successive records, in an incremental manner, allows reconstructing how the treatment has been conducted and allows identifying, or at the very least suspecting, the causes having led to breakage. These might be a misuse of the instrument (20) if the practitioner has used unsuited instrumental dynamics, or insufficient irrigation.

Of course, the geometry of the canal (42) is the major criterion leading to instrumental break. The a posteriori analysis of a large number of completed treatments allows identifying, for treatments having common parameters, which are the conditions that have led to breakage or, on the contrary, have led to the success of the treatment.

Of course, the common parameters are the use of the same instrument model (20), as well as a similar geometry of the root canal (42).

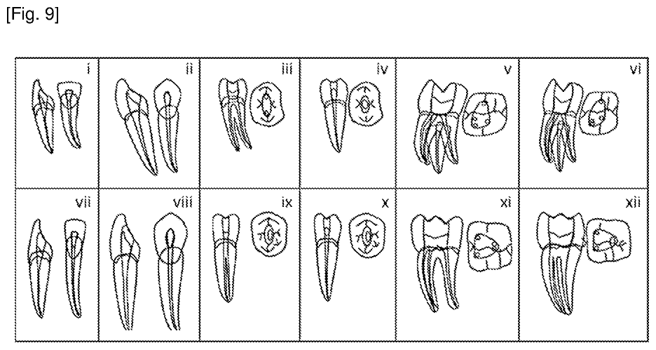

Referring to FIG. 9, different types of geometries (i-xii) of canals (42) are illustrated. Each geometry (i-xii) has a more or less complex treatment difficulty. For example, the profile (x) is rectilinear and has no particular difficulty. On the other hand, although generally rectilinear, the profile (ix) has a bifurcation at which the practitioner should ensure that the instrument (20) is not oriented towards the wrong extension.

Preferably, the record database comprises the records derived from as many practitioners as possible, in order to have a sufficient population of data of different treatments, and in particular of different geometries of canals (42). Hence, the analysis made from the records is more complete, and allows limiting the impact of some usage biases.

For example, these usage biases may be a practitioner who has a tendency to always prefer a first instrument model (20) for a type of treatment and a given canal geometry (42), while another practitioner prefers another instrument model (20). The analysis of the records allows ruling on the instrument model (20), the instrumental dynamics, or the most suitable gesture.

The constitution of the record database has two purposes:
a first use is to allow for new continuous improvement actions conducted by the equipment manufacturers;
a second use is to be able to identify, for a tooth (40) to be treated, which will be the risk zones, how to approach them so that the treatment is a success, and, on the contrary, the conditions very probably leading to an instrument break.

Based on the acquisition of the geometry of a canal (42) to be treated, the computer program is programmed to identify within the database which is the profile (i-xii) that approaches it most, consequently which will be the risk zones requiring vigilance by the practitioner, and possibly an adaptation of the gesture or the instrumental dynamics.

This a priori analysis allows guiding the practitioner during the treatment.

When the practitioner performs the treatment, the depth meter (11) detects at which working depth (Lp) the instrument is located. If it turns out that the working depth (Lp) is close to the depth of a risk zone, the practitioner is warned so that he/she takes the necessary precautions.

For this purpose, the control unit (30) activates means for warning the handpiece (10). This may consist of an audible warning, a haptic warning such as a vibration, or more simply a visual warning displayed by the interface (31).

For example, a colour code may be associated with three risk levels:
a first colour, for example green, means that the instrument (20) is not in a break risk situation;
a second colour, for example yellow, means that the probability of occurrence of breakage is average, a vigilance of the practitioner could be enough;
a third colour, for example red, means that the probability of occurrence is high and that an adaptation is imperative.

Advantageously, the computer program also takes account of the level of the mechanical stresses measured by the measurement means (13), so as to refine the analysis and to guide the practitioner more accurately: for example, It is useless to overly warn the practitioner if he/she is in a risk zone but the necessary adaptations are implemented.

This means that, if the instrument (20) approaches a risk zone (44) but the practitioner has adapted the instrumental dynamics:
for example by reducing the rotational speed of the instrument (20);
or if the practitioner performs much softer movements so as to exert only light mechanical stresses on the instrument (20);
then the computer program takes account of these adaptations in real-time in order to adapt the warning signal, so as not to emit false warnings.

Conversely, if the measurement means (13) detect that the conditions of use of the instrument (20) are not compliant with the risk level of the zone approached by the instrument (20), for example with inappropriate instrumental dynamics or excessive forces applied to the instrument (20), then the computer program is programmed to issue a warning corresponding to a high break occurrence probability.

Finally, the computer program may be programmed to automatically adapt the dynamics of the motor driving the instrument (20) if it detects that the probability of break is too great: the rotational speed could be decreased, or the motor drive could be stopped.

Complementarily, the computer program is programmed so as to be able to adapt, by artificial intelligence, the teachings derived from the analysis of the prior records to a new canal geometry (42) or to a new instrument reference (20).

For example, a modification of the material of the instrument (20) may be taken into account and a posteriori analyses may be re-calculated based on the new parameters, to obtain a simulation of what such a modification would produce. The same applies for modifications of the geometry of the instrument (20), and more generally for any influential parameter.

Or, if a canal (42) has for example a bend or a bifurcation at a depth different from what is known within the database, the computer program is programmed to nevertheless identify this critical zone so that the guidance of the practitioner is effective and efficient during the treatment.

Moreover, the method and the handpiece (10) may be made differently from the given examples without departing from the scope of the invention, which is defined by the claims.

In particular, the control unit (30) generally covers any electronic equipment used for the implementation of the methods and of the described handpiece (10). Hence, these consist of the microcomputer integrated into the handpiece (10), but also of any computer or smartphone used by the practitioner and capable of executing the computer program, uploading into or downloading records from the database.

The term “computer program” should also be interpreted in a broad sense, and covers the sub-programs and the complementary functionalities implemented in the described methods. Without limitation, these consist of:
the program controlling the motor of the handpiece (10);
the program for acquiring the data measured by the depth meter (11) and the measurement means (13), as well as their records;
the posteriori analysis program by finite-element calculation of the conditions of use of the instrument (20) in the different configurations;
the program for analysing the records allowing establishing the profiles of teeth (40) and of canals (42) to be treated, including the critical zones corresponding thereto;
the a priori analysis program of the critical zones of a canal to be treated (42).

In a simpler embodiment, it is the practitioner who marks which zones are at risk, without using any database. For this purpose, the practitioner uses the acquisition of the geometry of the canal (42) to be treated, and enters the depths of the risk zones based on his/her own analysis. During the treatment, the handpiece (10) is capable of warning the practitioner when he/she approaches a risk zone, based on the measurements made by the depth meter (11).

Furthermore, all or part of the technical features of the aforementioned different embodiments and variants could be combined with one another. Thus, the method and the handpiece (10) could be adapted in terms of cost, functionalities and performance.

1-5. (canceled)

6. for warning of a risk of break of an instrument during an endodontic treatment, remarkable in that it comprises the following steps of:
acquiring data of a geometry of a root canal to be treated;
identifying a risk zone, based on complexities of the geometry of the canal such as bends or bifurcations of the canal;
acquiring in real-time a working depth of the instrument; and
determining a position of the instrument within the canal, and issuing a warning when the instrument reaches the risk zone.

7. The method according to claim 6, wherein the warning is visual, audible, or haptic.

8. The method according to claim 6, further comprising a step of comparing the geometry of the root canal to be treated with a database comprising records of prior root canal treatments, the records comprising:
geometries of the treated canals;
local stresses within a material making up instruments used, obtained by finite-element calculation based on the geometry of the canal, a geometry of the instrument, a working depth of the instrument at a given interval and a stress experienced by the instrument at that same given interval;
the step of comparing with the records of the prior treatments allowing identifying risk zones of the canal to be treated, where local stresses will be high within the instrument.

9. The method according to claim 6, further comprising a step of adapting instrumental dynamics when the instrument reaches the risk zone.

10. A handpiece for endodontic practice, comprising a control unit executing a computer program, and designed to drive a canal instrument, wherein the handpiece comprises means for detecting a distance between a reference point and a portion of a tooth, as well as means for measuring mechanical stresses experienced by the instrument, connected to the control unit; wherein the computer program is programmed to determine a depth at which the instrument at work is located according to a known length of the instrument; wherein the computer program is configured to detect risk zones of the canal to be treated by comparing its geometry with records of prior treatments, the records comprising:
geometries of treated canals;
local stresses within a material making up instruments used, obtained by finite-element calculation based on the geometry of the canal, a geometry of the instrument, a working depth of the instrument at a given interval and a stress experienced by the instrument at that same given interval;
wherein the computer program is configured to warn the practitioner when the instrument is in a risk zone.
